(19) United States
(12) Patent Application Publication
(10) Pub. No.: US 2024/0400412 A1
(43) Pub. Date: Dec. 5, 2024

(54) METHOD FOR REMOVING DISSOLVED ORGANIC SUBSTANCES IN LIQUIDS USING A SUPERFINE ADSORBENT, AND MEANS FOR CARRYING OUT THE METHOD

(71) Applicant: Mecana AG, Reichenburg (CH)

(72) Inventors: Ulrich GRABBE, Buttikon (CH); Thomas FUNDNEIDER, Reichenburg (CH)

(73) Assignee: Mecana AG, Reichenburg (CH)

(21) Appl. No.: 18/697,089

(22) PCT Filed: Nov. 28, 2022
(86) PCT No.: PCT/EP2022/083470

§ 371 Date: Mar. 29, 2024

(30) Foreign Application Priority Data
Nov. 29, 2021 (DE) 10 2021 131 310.4

(51) Int. Cl. C02F 1/00; C02F 1/28; C02F 1/52; C02F 101/30

(52) U.S. Cl. CPC C02F 1/001; C02F 1/281; C02F 1/283; C02F 1/285; C02F 1/5245; C02F 2101/30; C02F 2209/001; C02F 2301/046

(57) ABSTRACT

A method for removing dissolved organic substances in liquids with a superfine adsorbent includes the method steps of measuring the concentration of dissolved organic substances in the liquid, adding pulverized activated carbon in the submicron range according to the measured concentration of organic substances to the liquid to be treated and mixing the powdered activated carbon with the liquid to be treated, leaving the mixture for a sufficient residence time to allow the powdered activated carbon to adsorb the dissolved organic substances in the liquid, and removing the pulverized activated carbon from the liquid by filtration.

### CROSS REFERENCE TO RELATED APPLICATIONS

This application is the National Stage of PCT/EP2022/083470 filed on Nov. 28, 2022, which claims priority under 35 U.S.C. § 119 of German Application No. 10 2021 131 310.4 filed on Nov. 29, 2021, the disclosure of which is incorporated by reference. The international application under PCT article 21 (2) was not published in English.

### BACKGROUND OF THE INVENTION

### 1. Field of the Invention

The invention relates to a method for removing dissolved organic substances in liquids with a superfine adsorbent in flow-through liquid systems in which the liquid flows from a liquid inlet to a liquid outlet. The invention also relates to an agent for carrying out the method.

### 2. Description of the Related Art

It is known from the prior art to use superfine adsorbents (d₅₀≤1-5 μm) such as superfine powdered activated carbon (sPAC) for adsorption to remove dissolved organic substances, such as dissolved organic carbon (DOC) or trace substances or micropollutants (e.g. pharmaceuticals, industrial and household chemicals) in liquids.

WO 2020/180513 A1 discloses a method for removing impurities from water, in particular groundwater and drinking water, which comprises the following steps:
adding pulverized activated carbon in the submicron range (sPAC) to an inflow of water to be treated;
mixing the sPAC with the water to be treated;
introducing a mixture of sPAC and water into a sorption reactor for treatment;
leaving the mixture in the sorption reactor for sufficient residence time to allow the sPAC to adsorb the impurities in the water; and

transferring the mixture from the sorption reactor using a recirculation pump to a high-speed ceramic membrane filter unit operating in cross-flow filtration, wherein the treated water is discharged as permeate and the sPAC is returned to the sorption reactor as retentate.

EP 1 146 016 A1 discloses a method for the pre-treatment of organically contaminated wastewater The fact that the method comprises the steps of filling the wastewater into a reactor, adding adsorbent and separating thin sludge provides a method for pre-treating organically contaminated wastewater that can pre-treat medium to large quantities of industrial wastewater quickly and effectively so that the pre-treated water can be fed directly into a bioreactor or to a further pre-treatment process.

JP 2019/162583 A describes a method for water treatment in which powdered activated carbon is added.

JP 2002/153866 A describes a method for treating wastewater containing dioxins by adding activated carbon.

JP 2004/351326 A describes a water quality monitoring system that enables the chlorine concentration to be controlled.

US 2019/0381478 A1 describes an activated carbon slurry process

The publication “Abscheidung ultrafeiner Pulveraktivkohle mittels Tuchfiltration” [Separation of ultra-fine powdered activated carbon by means of cloth filtration], Philipp Hodel, HSR Hochschule für Technik Rapperswil, Bachelorarbeiten 2017, with cloth filters.

### SUMMARY OF THE INVENTION

The object of the invention involves creating a method for removing (dissolved) organic substances in flow-through liquid systems with a superfine adsorbent.

This object is achieved according to the invention by a method having the following method steps:
measuring the concentration of dissolved organic substances in the liquid inlet and in the liquid outlet,
adding a superfine adsorbent with a particle diameter d50 of 0.1 to 5 μm according to the measured concentration of organic substances to the liquid to be treated and mixing the superfine adsorbent with the liquid to be treated, wherein the superfine adsorbent is stored and added in the form of a suspension;
leaving the mixture for a residence time of ≤1-10 min to allow the superfine adsorbent to adsorb the dissolved organic substances in the liquid; and
removing the superfine adsorbent from the liquid by cloth filtration, preferably by pile filtration or by a spatial filtration process.

The invention has shown that it is useful to adjust the amount of superfine adsorbent to the amount of dissolved organic substances contained in the liquid in order to always add sufficient superfine adsorbent on the one hand and to avoid overdosing on the other.

The short reaction time of the superfine adsorbent with dissolved organic substances and the resulting difference in concentration between the inlet and the outlet, which is recorded via online measurement, enables real-time regulation/control of the addition of the superfine adsorbent, adapted to the to the concentration in the liquid outlet or removal. Expediently, the concentration of dissolved organic substances is measured (as individual substances or by means of sum parameters) and the addition of the superfine adsorbent is regulated or controlled based on this measurement.

A preferred, but not exclusive, field of application of the method according to the invention is groundwater decontamination, municipal and industrial wastewater treatment and water treatment, in particular the filtration of wastewater after chemical and biological treatment, which is the fourth treatment stage in wastewater treatment plants. Filtration within the meaning of the invention is understood to mean all methods of surface and spatial filtration, in particular cloth filtration and, in particular, pile filtration.

Cloth filtration processes and especially pile filtration processes have proven to be particularly effective and economical in the context of the invention. Depending on the particle diameter of the superfine adsorbent used, a correspondingly fine filter cloth can be used.

In the case of high dosages and/or to improve the separation of superfine adsorbent by means of a filter cloth, multi-stage, in particular two-stage filtration can be used in the method, wherein filter cloths of different finenesses can also be used in multi-stage filtration.

The liquid supplied to the filtration system flows through the filter cloth, wherein the organic substances and other solids are retained. The retention increases the resistance of the cloth, so that it is necessary to remove the accumulated and embedded solids. Cleaning is level-controlled, time-controlled or manually triggered by the suction of the filter cloth. Filtration is not interrupted during the extraction of the filter cloth. As mentioned above, the rinsing/process water produced here is preferably at least partially fed back into the process or returned to upstream process steps.

Separate treatment/utilization of the rinsing water is also possible.

The method according to the invention is suitable for flow-through liquid systems in which the liquid flows from a liquid inlet to a liquid outlet. It makes sense to measure the concentration of dissolved organic substances both in the liquid inlet and in the liquid outlet. This enables the creation of a self-learning or self-regulating system, as the determined empirical values regarding the concentration of dissolved organic substances in the liquid inlet and in the liquid outlet as well as the amount of superfine adsorbent added in each case can be used to ensure that the appropriate amount of superfine adsorbent is added in each case. The dosing of the superfine adsorbent is controlled and/or regulated depending on the remaining dissolved organic substances in the liquid outlet or the ratio of “dissolved organic substances in the liquid outlet” to “dissolved organic substances in the liquid outlet”. UV-vis probes or TOC/DOC analyzers, for example, can be used for online measurement of the concentration of dissolved organic substances. Due to the small particle diameter of the superfine adsorbent, a very short reaction time is achieved to remove the organic substances. Based on the concentration differences between the liquid inlet and the liquid outlet, which are recorded via an online measurement, the real-time regulation/control of the addition of the superfine adsorbent takes place, adapted to the concentration in the liquid outlet or an effective removal. This ensures that superfine adsorbent is always added as required to ensure constant removal of the dissolved organic substances.

In this connection, it is advantageous that the liquid is returned from the liquid outlet to the liquid inlet if a set value of dissolved organic substances in the liquid outlet is exceeded.

This ensures that no liquid escapes from the liquid outlet with a content of dissolved organic substances above the target value.

It is within the scope of the invention that the superfine adsorbent is added in a dosage of 0.1 to 1,000 mg/l, preferably 1 to 100 mg/l, particularly preferably 2 to 20 mg/l.

The dosage varies depending on the dissolved organic substances and the superfine adsorbent used, or their interaction with each other.

It is advantageous that the superfine adsorbent has a particle diameter d₅₀ of 0.5 to 5 μm and particularly preferably 0.8 to 3 μm.

The large specific surface area of the superfine adsorbent leads to faster removal of the dissolved organic substances after just a few minutes (≤1-10 min) compared to adsorbents with a larger particle diameter (d₅₀>5-10 μm). This also results in a lower adsorbent requirement while maintaining the removal of dissolved organic substances.

It is advantageous that the superfine adsorbent is added in the form of a suspension, preferably with a concentration of 5 to 30% by weight, preferably 8 to 25% by weight and particularly preferably 10 to 15% by weight in the case of activated carbon as the adsorbent.

When incorporated into a suspension, the superfine adsorbent, such as activated carbon, does not pose an explosion hazard. When using granulated activated carbon as a raw material for the production of superfine adsorbent, there is no explosion hazard (no explosion protection area) during the process—from the storage of the raw material to the use of the suspension.

The suspension is produced in batches or continuously, directly on site or externally. For this purpose, the adsorbent is ground, for example in a ball mill. In a single-stage grinding process and the use of activated carbon as the adsorbent, finely granulated (≤500 μm) or powdered activated carbon (≤500 μm) can be used as starting material, wherein the grinding time is <5-60 min to produce superfine activated carbon with a target particle diameter of d₅₀≤1-5 μm. Grinding takes place in a single-stage process with activated carbon (≤500 μm) as the adsorbent. According to DIN EN 12915-1:2009-07, granulated activated carbon is a granular product; depending on the agreement, a mass fraction of at least 90% is retained on a 180 μm test sieve. According to DIN EN 12903:2009-07, powdered activated carbon has a particle size of less than 150 μm, with a mass fraction of 95%.

According to the invention, the superfine adsorbent can contain activated carbon and/or bentonite and/or zeolite and/or polymeric adsorbents and/or silica gel as well as mixtures thereof.

In principle, any adsorbent that can adsorb the dissolved organic substances is suitable. These can be, for example, anthropogenic organic trace substances (such as active pharmaceutical ingredients, X-ray contrast agents, substances from personal care and cleaning products, biocides, flame retardants, perfluorinated chemicals) and/or organic carbon compounds. The raw material of the superfine adsorbent is usually in powder and/or granulated form and consists of substances that are adapted to the dissolved organic substances or the water matrix. Furthermore, the adsorbent can contain appropriate additives, such as metal salts (e.g. bivalent or trivalent iron and/or aluminum salts) and/or (cationic, anionic and/or non-ionic) polymers to improve the properties, such as the outlet quality with regard to separation by a filter cloth. Such additives can be added both before and after preparation of the suspension.

A further development of the invention consists of the superfine adsorbent containing additives, in particular metal salts and/or polymers.

The suspension containing the superfine adsorbent may already contain additives, such as metal salts and/or polymers, so that they can be added together in the method. The additives are added either directly during the production of the suspension or afterwards. Alternatively, the additives can also be added to the liquid separately from the superfine adsorbent. For better separation of the superfine adsorbent during filtration, the addition of metal salts and/or polymers is optionally possible, for example, which are also added to the liquid inlet for filtration and/or the upstream contact reactor. It can be added at the same time as the superfine adsorbent or shortly after it has been added. The dosage of the additives must be adjusted depending on the process and is usually proportional to the quantity of superfine adsorbent. The solids concentration in the liquid flow can be used as a regulating or control variable for the additive quantity.

Preferably, the superfine adsorbent is added to the liquid inlet.

The liquid inlet is defined here as the area before filtration in which the liquid is treated. For example, this can be the liquid inlet of the filtration system of a sewage treatment plant. By adding the superfine adsorbent to the liquid inlet of the filtration, the reaction time for removing the organic substances corresponds to the hydraulic residence time of the method, which should be ≤1-60 min at maximum filtration speed. Thus, depending on the reactive behavior of the organic substances, a separate contact reactor for the action of the superfine adsorbent prior to removal from the liquid can be dispensed with. To decouple the reaction time from the hydraulic residence time, it is possible to (partially) recirculate the rinsing/process liquid produced during filtration into the liquid inlet of the filtration or in a contact reactor upstream of the liquid inlet.

This method is used to treat liquids (such as municipal or industrial wastewater, drinking water, groundwater, lake, sea and river water, rainwater, combined wastewater and road runoff) with the aim of removing dissolved organic substances such as dissolved organic carbon (DOC) and trace substances or micropollutants (e.g. pharmaceuticals, industrial and household chemicals) and/or inorganic substances such as phosphates, ammonium compounds or metals.

The at least one adsorbent is mixed with at least one powdered or liquid flocculant after production and before being added to the water treatment process, and the resulting agent, which contains at least one adsorbent and at least one flocculant, is used to treat the liquids.

Preferably, a suspension of adsorbent and flocculant, wherein the concentration of the suspension of adsorbent and flocculant is cumulatively between 2 and 40% by weight, preferably between 5 and 30% by weight and particularly preferably between 10 and 25% by weight.

The addition of a suspension of adsorbent and flocculant ensures that the adsorbent and flocculant are added at the same point and at the same time in the process.

In this context, it is preferred that the pH value of the suspension is less than 4 or greater than 10, preferably less than 2.5 or greater than 11.5. The pH value of the liquid treated with the agent is preferably in the range between 5 and 10, preferably between 6.5 and 8.5, after addition of the agent according to the invention.

The at least one adsorbent is preferably selected from the group consisting of activated carbon, bentonite, zeolite, polymeric adsorbents, silica gel, iron oxide, iron hydroxide or mixtures thereof.

In principle, any adsorbent that can adsorb the dissolved, in particular organic substances is suitable. These can be, for example, anthropogenic organic trace substances (such as active pharmaceutical ingredients, X-ray contrast agents, substances from personal care and cleaning products, biocides, flame retardants, perfluorinated chemicals) and/or organic carbon compounds. The raw material of the adsorbent is usually in powdered form (such as powdered activated carbon (PAC)) and/or superfine powdered activated carbon (sPAC) and consists of substances that are adapted to the dissolved organic substances or the water matrix. Preferably, the raw material of the adsorbent consists of renewable or regenerative raw materials.

Due to the suspended form of the adsorbent, even when using superfine adsorbents, there is no explosion hazard (no explosion protection area) over the entire process duration—from storage to use. The form of the agent also enables simple and needs-based dosing, for example depending on the concentration or/and mass of organic substances to be removed or/and the amount of water to be treated, into the method step. The agent enables an efficient and short application before the separation process. When using sPAC to remove >80% of organic trace substances, the necessary contact time is significantly less than 5 minutes.

A preferred embodiment of the invention is that at least two different adsorbents are contained, which preferably also have different particle diameters. One of the adsorbents should always be superfine; the other(s) can be fine. For example, it may be provided that a first adsorbent with a particle diameter in the range of 0.1 to 10 μm, preferably 0.8 to 2 μm, and a further adsorbent with a particle diameter in the range of 5 to 50 μm, preferably 5 to 15 μm, are contained in the agent.

The at least one flocculant is selected from the group consisting of divalent or trivalent metal salts, in particular iron (III) chloride, iron (III) chloride sulfate, aluminum iron (III) chloride, aluminum iron (III) sulfate, aluminum iron (III) chloride sulfate, aluminum iron (III) hydroxide chloride, sodium aluminate and polyaluminum chloride, wherein the suspension contains 1 to 2,000 mg, preferably 10 to 500 mg, particularly preferably 50 to 200 mg of flocculant per 1 g of dry adsorbent mass.

According to the invention, additional additives can also be contained.

The additives can be powdered or liquid.

It is also possible to combine powdered and liquid additives with each other.

Preferably, the additives are selected from the group consisting of hydrochloric acid, caustic soda and dispersing agents.

These additives are used to improve separation in the process of preparing the liquids and as stabilizers or dispersants for the ingredients of the product.

In the following, various embodiments for the agent according to the invention are shown in the form of batches by way of example using superfine powdered activated carbon (sPACd50=1 μm; 10%) as the adsorbent and iron (III) chloride as the flocculant.

Each batch contains a different adsorbent to flocculant ratio.

The following table shows six batches with different concentrations of sPAC in the suspension with different amounts of iron and the resulting pH value in each case.

| | sPAC | Fe³⁺/sPAC | pH value (21° C.) |
|---|---|---|---|
| Batch | [g/l] | [mg/g] | [-] |
| 1 | 99 | 48 | 2.1 |
| 2 | 98 | 92 | 1.7 |
| 3 | 96 | 194 | 1.4 |
| 4 | 91 | 329 | 1.1 |
| 5 | 87 | 493 | 0.8 |
| 6 | 78 | 817 | 0.4 |

The addition of 10 mg sPAC/I including the corresponding amount of flocculant (Fe³⁺/sPAC) leads to a decrease in the spectral absorption coefficient (SAC, at the wavelength of 254 nm a measure for organic substances, at the wavelengths 436 nm, 525 nm, 620 nm for the true coloring) at the wavelengths 254 nm, 436 nm, 525 nm and 625 nm as well as the phosphorus concentration.

The decrease in the spectral absorption coefficient at wavelengths of 254 nm serves as a surrogate parameter for organic substances such as DOC and trace substances. In addition to the removal of phosphate, iron (III) chloride is also beneficial as a flocculant for superfine powdered activated carbon.

The lower the turbidity in the suspension, the more efficient the agglomeration of the superfine adsorbent and its removability in subsequent separation processes.

| | Suspension with 10 mg | | | | | | | |
|---|---|---|---|---|---|---|---|---|
| | sPAC/l | | | | | | | |
| | pH value | Con | | Filtrate (0.45 μm) | | | | |
| | (21° C.) | (22° C.) | Turbidity | PO₄—P | SAC_{254 nm} | SAC_{436 nm} | SAC_{525 nm} | SAC_{620 nm} |
| Batch | [—] | [μS/cm] | [NTU] | [μg/l] | [1/m] | [1/m] | [1/m] | [1/m] |
| Zero | 7.5 | 920 | 1.4 | 54 | 13.22 | 0.21 | 0.13 | 0.04 |
| 1 | 7.5 | 920 | 19.0 | 32 | 9.60 | 0.10 | 0.02 | 0.00 |
| 2 | 7.4 | 922 | 16.7 | 11 | 9.35 | 0.08 | 0.10 | 0.00 |
| 3 | 7.5 | 920 | 15.8 | 4 | 8.97 | 0.07 | 0.14 | 0.00 |
| 4 | 7.5 | 931 | 17.4 | 3 | 8.70 | 0.05 | 0.00 | 0.00 |
| 5 | 7.5 | 932 | 19.9 | 2 | 8.14 | 0.04 | 0.00 | 0.00 |
| 6 | 7.4 | 932 | 21.8 | 2 | 7.77 | 0.01 | 0.00 | 0.00 |

The removal of phosphate is not disturbed by the adsorbent-flocculant mixture.

The following table shows that there is corresponding phosphate removal, wherein the decrease in the spectral absorption coefficient is negligible.

| | Suspension without | | | | | | | |
|---|---|---|---|---|---|---|---|---|
| | sPAC with Fe³⁺ | | | | | | | |
| | pH value | Con | | Filtrate (0.45 μm) | | | | |
| Fe³⁺ | (21° C.) | (22° C.) | Turbidity | PO₄—P | SAC_{254 nm} | SAC_{436 nm} | SAC_{525 nm} | SAC_{620 nm} |
| [mg/l] | [—] | [μS/cm] | [NTU] | [μg/l] | [1/m] | [1/m] | [1/m] | [1/m] |
| 0 | 7.5 | 920 | 1.4 | 54 | 13.22 | 0.21 | 0.13 | 0.04 |
| 1 | 7.6 | 921 | 1.7 | 22 | 13.22 | 0.19 | 0.10 | 0.02 |
| 3 | 7.6 | 927 | 2.5 | 3 | 12.58 | 0.16 | 0.07 | 0.00 |

The decrease in the spectral absorption coefficient at the wavelengths 254 nm, 436 nm, 525 nm and 625 nm is not disturbed by the adsorbent-flocculant mixture. The adsorption mechanisms are not affected by the combination of superfine adsorbent and iron (III) chloride. There is no phosphate removal, wherein adsorptively available phosphorus fractions would be removed by the use of the adsorbent.

| | Suspension with 10 mg | | | | | | | |
|---|---|---|---|---|---|---|---|---|
| | sPAC/l without Fe³⁺ | | | | | | | |
| | pH value | Con | | Filtrate (0.45 μm) | | | | |
| AC | (21° C.) | (22° C.) | TB | PO₄—P | SAC_{254 nm} | SAC_{436 nm} | SAC_{525 nm} | SAC_{620 nm} |
| [mg/l] | [—] | [μS/cm] | [NTU] | [μg/l] | [1/m] | [1/m] | [1/m] | [1/m] |
| 0 | 7.5 | 920 | 1.4 | 54 | 13.22 | 0.21 | 0.13 | 0.04 |
| 10 | 7.6 | 920 | 18.8 | 54 | 9.67 | 0.11 | 0.00 | 0.00 |

TB: Turbidity
Con: Conductivity
NTU = Nephelometric turbidity unit

The comparison between the joint addition of adsorbent and flocculant and the separate use of adsorbent and flocculant shows that there is no difference in terms of the decrease in phosphate and the spectral absorption coefficient at the wavelengths 254 nm, 436 nm, 525 nm and 625 nm.

| | | Suspension with 10 mg | | | | | | | |
|---|---|---|---|---|---|---|---|---|---|
| | | sPAC/l and separate Fe³⁺ | | | | | | | |
| | | pH value | Con | | Filtrate (0.45 μm) | | | | |
| AC | Fe³⁺ | (21° C.) | (22° C.) | TB | PO₄—P | SAC_{254 nm} | SAC_{436 nm} | SAC_{525 nm} | SAC_{620 nm} |
| [mg/l] | [mg/l] | [—] | [μS/cm] | [NTU] | [μg/l] | [1/m] | [1/m] | [1/m] | [1/m] |
| 0 | 0 | 7.5 | 920 | 1.4 | 54 | 13.22 | 0.21 | 0.13 | 0.04 |
| 10 | 1 | 7.7 | 920 | 16.7 | 7 | 9.05 | 0.05 | 0.00 | 0.00 |
| 10 | 3 | 7.6 | 923 | 15.6 | 3 | 8.66 | 0.05 | 0.00 | 0.00 |

### BRIEF DESCRIPTION OF THE DRAWINGS

In the following, an exemplary embodiment of the invention is explained in more detail on the basis of the drawing.

In the drawing:

FIG. 1 shows a schematic diagram of the method according to the invention when used in a flow-through system.

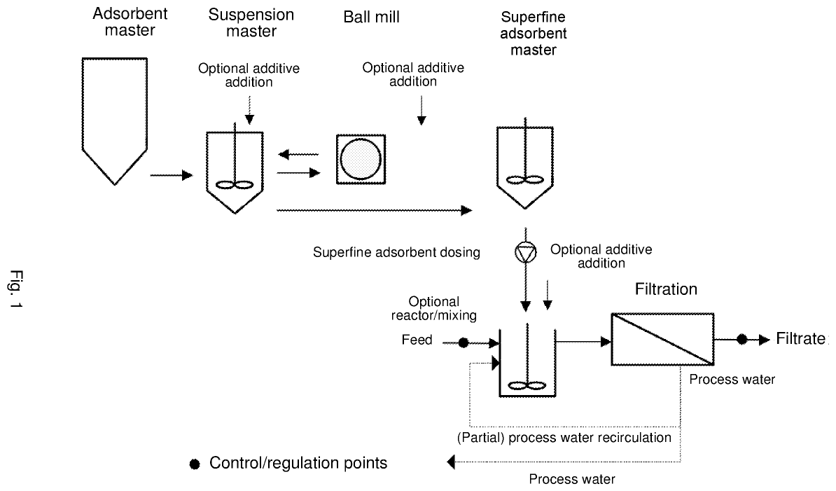

### DETAILED DESCRIPTION OF PREFERRED EMBODIMENTS

A suspension is formed from a master adsorbent, which in the present case contains pulverized activated carbon in the form of granulated or powdered activated carbon, and a master suspension, which in the present case contains water, wherein the pulverized activated carbon is present in the suspension at a concentration of less than 5 to 30% by weight, preferably 8 to 25% by weight and particularly preferably 10 to 15% by weight.

This suspension is fed into a ball mill. During a grinding time of 5-60 min, a suspension with superfine adsorbent (such as preferably powdered activated carbon) with a particle diameter of d₅₀ of 0.1 to 10 μm, preferably of 0.5 to 5 μm and particularly preferably of 0.8 to 3 μm is obtained. Grinding preferably takes place in a single-stage process. The resulting product is stored in the superfine adsorbent master.

In the method according to the invention for removing dissolved organic substances in liquids using a superfine adsorbent, the concentration of dissolved organic substances in the liquid is measured and superfine adsorbent is added to the liquid to be treated according to the measured concentration of organic substances and the superfine adsorbent is mixed with the liquid to be treated. In the case of activated carbon as an adsorbent, the powdered activated carbon in the form of a suspension is dosed into the liquid inlet from the superfine adsorbent master in a dosage of 1 to 1,000 mg/l, preferably 1 to 100 mg/l, particularly preferably 2 to 20 mg/l activated carbon.

The mixture is then left for a sufficient reaction time to allow the superfine adsorbent to adsorb the dissolved organic substances in the liquid. At the end of the residence time, the superfine adsorbent is removed from the liquid. After the intended reaction time, the superfine adsorbent is preferably removed from the liquid by cloth filtration, particularly preferably by polymer filtration, wherein multi-stage, in particular a two-stage filtration can also be provided.

Preferably, the concentration of dissolved organic substances is measured both in the liquid inlet and in the liquid outlet and, if a target value of dissolved organic substances is exceeded in the liquid outlet, the liquid is returned from the liquid outlet to the liquid inlet.

1: A method for removing dissolved organic substances in liquids with a superfine adsorbent in flow-through liquid systems in which the liquid flows from a liquid inlet to a liquid outlet, having the following method steps:
measuring the concentration of dissolved organic substances in the liquid inlet and in the liquid outlet;
adding a superfine adsorbent with a particle diameter d₅₀ of 0.1 to 5 μm according to the measured concentration of organic substances to the liquid to be treated and mixing the superfine adsorbent with the liquid to be treated, wherein the superfine adsorbent is stored and added in the form of a suspension;
leaving the mixture for a residence time of ≤1-10 min to allow the superfine adsorbent to adsorb the dissolved organic substances in the liquid; and
removing the superfine adsorbent from the liquid by cloth filtration, preferably by pile filtration or by a spatial filtration process.

2: The method according to claim 1, wherein the liquid is returned from the liquid outlet to the liquid inlet if a set value of dissolved organic substances in the liquid outlet is exceeded.

3: The method according to claim 1, wherein the superfine adsorbent is added in a dosage of 0.1 to 1,000 mg/l, preferably 1 to 100 mg/l, particularly preferably 2 to 20 mg/l.

4: The method according to claim 1, wherein the superfine adsorbent has a particle diameter d₅₀ of 0.5 to 5 μm and particularly preferably 1 to 3 μm.

5: The method according to claim 1, wherein the superfine adsorbent is added in the form of a suspension, preferably with a concentration of 5 to 30% by weight, preferably 8 to 25% by weight and particularly preferably 10 to 15% by weight.

6: The method according to claim 1, wherein the superfine adsorbent contains activated carbon and/or bentonite and/or zeolite and/or polymeric adsorbents and/or silica gel and/or iron oxide and/or iron hydroxide or mixtures thereof.

7: The method according to claim 1, wherein the superfine adsorbent contains additives, in particular metal salts and/or polymers.

8: The method according to claim 1, wherein the superfine adsorbent is added to the liquid inlet.

9. (canceled)

10: The method according to claim 1, wherein a multi-stage, in particular a two-stage filtration is provided.

11-15. (canceled)

16: The method according to claim 1, wherein the suspension contains at least one flocculant selected from the group consisting of divalent or trivalent metal salts, in particular iron (III) chloride, iron (III) chloride sulfate, aluminum iron (III) chloride, aluminum iron (III) sulfate, aluminum iron (III) chloride sulfate, aluminum iron (III) hydroxide chloride, sodium aluminate and polyaluminum chloride, wherein the suspension contains 1 to 2,000 mg, preferably 10 to 500 mg, particularly preferably 50 to 200 mg of flocculant per 1 g of dry adsorbent mass.
